(19) United States
(12) Patent Application Publication
(10) Pub. No.: US 2003/0113118 A1
(43) Pub. Date: Jun. 19, 2003

(54) Smart single fiber optic transceiver

(76) Inventor: Meir Bartur, Los Angeles, CA (US)

Correspondence Address: David L. Henty, Myers, Dawes & Andras LLP, Suite 1150, 19900 MacArthur Blvd., Irvine, CA, 92612, US

(21) Appl. No.: 10/304,393

(22) Filed: Nov. 26, 2002

Related U.S. Application Data
(60) Provisional application No. 60/333,790, filed on Nov. 28, 2001.
(60) Provisional application No. 60/381,655, filed on May 16, 2002.

(51) Int. Cl. H04B 10/00

(52) U.S. Cl. 398/139; 398/22

(57) ABSTRACT

A fiber optic transceiver adapted for use in an optical fiber data transmission system is capable of detecting fiber connection problems and providing visual or other indications of a problem. The fiber optic transceiver contains a fiber interface, a receiver, a transmitter, and a microcontroller. The microcontroller controls the transmitter to modulate the laser power to transmit test data and the transceiver includes circuitry and microcode to detect fiber connection problems, including reflection and cross connections. This enables trouble shooting during installation and/or reconfiguring the connection automatically, in response to a connection problem, and provides a physical layer link.

### RELATED APPLICATION INFORMATION

The present application claims priority under 35 USC 119 (e) of provisional application serial No. 60/333,790 filed Nov. 28, 2001 and provisional application serial No. 60/381,655 filed May 16, 2002, the disclosures of which are incorporated herein by reference in their entirety.

### BACKGROUND OF THE INVENTION

1. Field of the Invention

The present invention relates to fiber optic transmitters and receivers and related optical networking systems and methods of transmitting and receiving data along optical networking systems.

2. Background of the Prior Art and Related Information

Fiber optic data distribution networks are becoming increasingly important for the provision of high bandwidth data links to commercial and residential locations. Such systems employ optical data transmitters and receivers (or “transceivers”) throughout the fiber optic distribution network. An important feature of a fiber optic network is the ability to easily add new connections to the network or to reconfigure the network in response to the user needs. When a new transceiver is added to an existing fiber optic network it may be coupled to a nearby transceiver or to a transceiver located a considerable distance away, depending on the particular network configuration. If a fault exists somewhere in the network an attempt to connect a new transceiver into the network will result in either data transmission failures or complete inability to connect to the network. For example, the fault may be a simple open fiber connection at the next transceiver or the next transceiver may not be functioning properly or may not be powered up. Alternatively, the fault may be in the fiber connection to the new transceiver being added to the network or may be some other fault somewhere in the network. Another type of problem can occur for single fiber systems where a single fiber is used to both transmit and receive data at the same light wavelength. In such a single fiber system reflections can occur which will be returned along the single fiber and detected as received data by the sending transceiver. It is obviously important for system operation to be able to detect if such reflections are present to avoid false data detection, however, discriminating reflections from real data can be extremely difficult.

Determining connection problems and determining which possible fault is causing the connection problems and where it is located may involve considerable time and inconvenience to the user of the network. Also, if a problem exists and is not detected during the initial installation of the transceiver faulty data transmission may occur resulting in either reduced data rates in the system or intermittent system failures depending on the manner in which the fiber optic network is being used. Therefore, it will be appreciated that these difficulties related to faults in installing or reconfiguring the transceivers in an optical network can waste considerable time and cause associated expenses related to maintenance and system downtime.

Accordingly, it will be appreciated that a need presently exists for a single fiber optical transceiver which can address the above noted problems. It will further be appreciated that a need presently exists for such an optical transceiver which can provide such capability without significant added cost or complexity.

### SUMMARY OF THE INVENTION

The present invention provides a single fiber optical transceiver adapted for use in an optical fiber data transmission system which is capable of detecting fiber connection problems and providing visual or other indications of a problem and/or reconfiguring the connection automatically, in response to a connection problem. The present invention further provides an optical transceiver which can provide such capability without added cost or complexity.

In a first aspect the present invention provides an optical transceiver, comprising a transmitter comprising a laser diode and a laser driver providing a drive signal to the laser diode, a receiver comprising a photodiode and signal recovery circuitry, and a microcontroller coupled to the transmitter and receiver and providing a modulated power control signal to the laser driver during a test mode to transmit test data and monitoring received signals to detect connection problems.

In a preferred embodiment, the laser driver has modulation and bias power control inputs and the microcontroller modulates the bias control input during said test mode. For example, the microcontroller may modulate the bias power control signal employing pulse width modulation. The receiver preferably includes a transimpedance amplifier coupled to the photodiode and the microcontroller monitors the output of the transimpedance amplifier using a comparator during the test mode. The comparator detects test data and provides a first output when the transimpedance amplifier output is above a threshold value and a second output when it is below the threshold value. Preferably, the transmitted test data and received test signals comprise low frequency signals, for example, MHz or KHz signals whereas user data comprises GHz signals. Preferably, the transceiver also comprises a visual indicator, which is activated to identify a fiber connection state detected during said test mode.

In a further aspect the present invention provides a fiber optic communication network, comprising an optical fiber and a first transceiver coupled to the single optical fiber. The first transceiver comprises a transmitter including a laser diode coupled to a single fiber and a laser driver providing a drive signal to the laser diode, a receiver including a photodiode coupled to a single fiber and signal recovery circuitry, and a microcontroller coupled to the transmitter and receiver and providing a modulated power control signal to the laser driver during a test mode to transmit test data and monitoring received signals to detect connection problems. The fiber optic communication network further comprises a second transceiver coupled to the optical fiber and comprising a transmitter including a laser diode coupled to the fiber and a laser driver providing a drive signal to the laser diode, a receiver including a photodiode coupled to the fiber and signal recovery circuitry, and a microcontroller coupled to the transmitter and receiver and providing a modulated power control signal to the laser driver to provide test data in response to received test data from said first transceiver.

In a preferred embodiment, the test data comprises data identifying the transceiver. The first transceiver monitors received signals for reflected test data identifying the first transceiver and such reflected test data indicates fiber connection problems. In one embodiment, the first transceiver transmits a short duration test signal when reflected test data is detected. The first transceiver includes a timer for detecting the time delay of the reflected test signals and the microcontroller determines whether a reflection is local or remote based on the time delay. Also, the microcontroller may control the power to the laser driver to increase the power for the short duration reflection test signal. In one embodiment, the microcontroller may also adjust the test signal detection threshold based on the detected reflection to enable normal data transmission despite the reflection.

In a further aspect, the present invention provides a method for fault detection in a fiber optic network. The method comprises transmitting a test signal by modulating a laser transmitter using a test transmission mode which is different than a data transmission mode during normal operating conditions and detecting any received signals modulated using said test transmission mode within a predetermined time period after said transmitting.

In a further aspect, the present invention provides a method for fault detection in a fiber optic network. The method comprises transmitting a test signal by modulating a laser transmitter using a test transmission mode which is different than a data transmission mode during normal operating conditions and detecting the time of arrival relative to the time of transmittal of any received signals modulated using said test transmission mode. The time difference provides a measure to the distance to the faulty reflection spot of the fiber.

In a preferred embodiment, the test transmission mode may comprise modulating the laser at a power levels above and below the minimum threshold for normal data transmission, modulating the laser at a frequency substantially lower than during normal data transmission, and/or modulating the laser using a different modulation scheme than normal data transmission. For example, the laser transmitter may have modulation and bias controls and the test transmission mode may comprise modulating the laser bias control setting using low frequency pulse width modulation. The test signal may comprise an ID characterizing the local transmitter. The method may further comprise determining whether a received test signal comprises the ID for the local transmitter. The method may further comprise initiating a short duration test pulse if the received test signals comprise the ID for the local transmitter, detecting the time delay for receiving the reflected test pulse and determining whether the reflection is local or remote based on the time delay. The method may also comprise increasing the laser transmitter power during transmission of said short duration test pulse.

In a further aspect, the present invention provides a method for determining a connection state of a fiber optic network. The method comprises connecting a local fiber optic transceiver to a fiber optic network comprising at least one optical fiber and at least one remote transceiver and initiating a test mode wherein the local fiber optic transceiver transmits optical test signals employing a transmission mode, which is different than for transmission of user data during normal operation. The method further comprises detecting any received signals modulated using the test transmission mode, identifying at least one connection state of the local fiber optic transceiver in the network based on the transmitting of test signals and detecting of received signals, and providing an indication of the connection state to a user.

In a preferred embodiment, the indication of the connection state to a user may comprise a visual indication. The at least one connection state may include a connection state indicating a reflection, which may be identified as local or remote.

In another preferred embodiment, the indication of the connection state comprise data fields in memory page of the microcontroller, accessible to the system via electrical interface.

Further features and advantages will be appreciated from a review of the following detailed description of the invention.

### BRIEF DESCRIPTION OF THE DRAWINGS

FIG. 1 is a block schematic drawing of a fiber optic data transmission system in accordance with the present invention.

FIG. 2 is a block schematic drawing of a transceiver coupled to a single optical fiber in accordance with the present invention.

FIG. 3 is a block schematic drawing of a microcontroller employed in the transceiver of FIG. 2, in accordance with a preferred embodiment of the present invention.

FIG. 4 is a state diagram showing a test mode of operation of a transceiver coupled to an optical fiber data transmission system in accordance with a preferred embodiment of the present invention.

FIG. 5 is a state diagram showing another test mode of operation of a transceiver coupled to an optical fiber data transmission system in accordance with a preferred embodiment of the present invention.

### DETAILED DESCRIPTION OF THE INVENTION

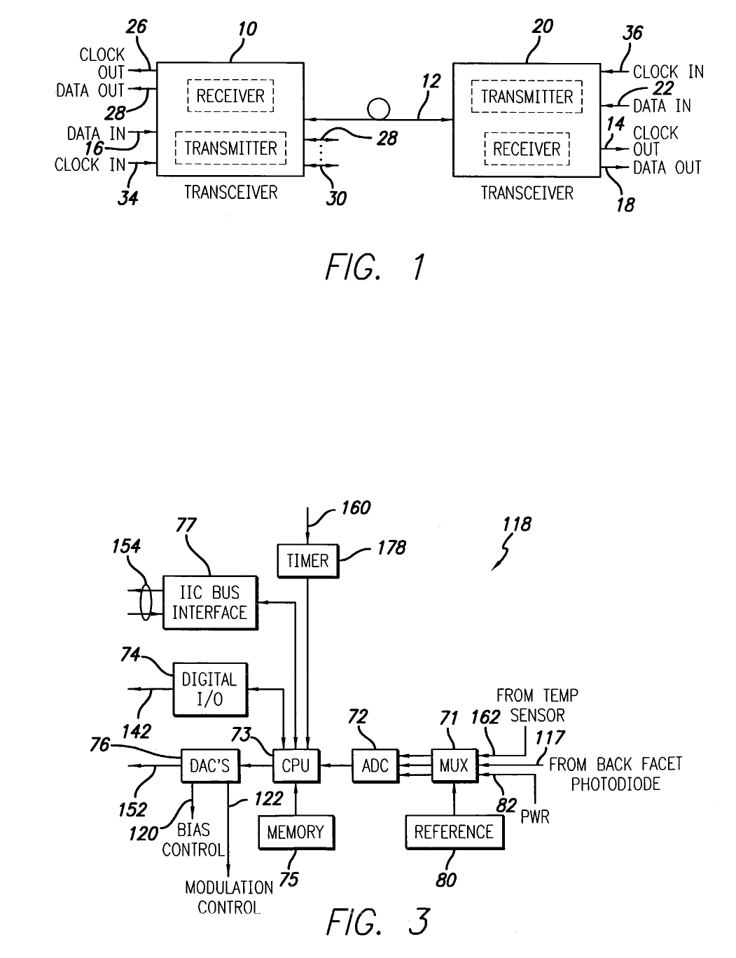

Referring to FIG. 1, a high-level block schematic drawing of a fiber optic data transmission system incorporating the present invention is illustrated.

As shown in FIG. 1, a first transceiver 10 is coupled to a second transceiver 20 via optical fiber 12. Both transceiver 10 and transceiver 20 include transmitter circuitry to convert input electrical data signals to modulated light signals coupled into fiber and receiver circuitry to convert optical signals provided along the optical fibers to electrical signals and to detect encoded data and/or clock signals. As indicated by the arrows on the optical fiber 12, transceiver 10 transmits data to transceiver 20 in the form of modulated optical light signals along optical fiber 12 and also receives optical signals from transceiver 20 along the same fiber 12. For example, wavelength division multiplexing may be employed. If wavelength division multiplexing is employed, transceiver 10 may provide data transmission to transceiver 20 employing a first wavelength of light modulated and transmitted along fiber 12 and transceiver 20 may provide data along fiber 12 to transceiver 10 employing a second wavelength of light. Without wavelength division multiplexing both transceivers may transmit and receive at the same wavelength. Alternatively transmission in the two directions may be provided in accordance with time division multiplexing or using other protocols. This bi-directional transmission along a single fiber is referred to herein as a single fiber system even though a given transceiver may be coupled to more than one transceiver and may therefore employ more than one fiber, as indicated generally by plural fibers 28-30.

More specifically referring to FIG. 1, input electrical data signals are provided along line 16 from outside data source as well as optional clock signal 36 to transceiver 10 for transmission to transceiver 20 as modulated light signals. Transceiver 20 in turn receives the light pulses, converts them to electrical signals and outputs data and optional clock signals along lines 18 and 14, respectively. Transceiver 20 similarly receives input electrical data signals along line 22 and optional clock along line 36, converts them to modulated light signals and provides the modulated light signals along fiber 12 to transceiver 10. Transceiver 10 receives the modulated light pulses, converts them to electrical signals and derives clock (optional) and data signals which are output along lines 26 and 28, respectively. Also, the clock inputs along lines 34 and 36 may be provided in a synchronous system in to improve jitter performance of the transmitters, are not necessary. The clock outputs along lines 26 and 14 are not necessary. It will further be appreciated that additional fiber coupling along fibers 28-30 to additional transceivers may also be provided for various applications and architectures and such additional transceivers are implied herein as part of an overall system.

In various applications data transmission along the optical fibers may be in burst mode or both burst and continuous modes at different times. This configuration may for example be employed in a passive optical network (PON) where transceiver 10 corresponds to an optical line terminator (OLT) whereas transceiver 20 corresponds to an optical networking unit (ONU). In this type of fiber optic data distribution network transceiver 10 may be coupled to multiple optical networking units and this is schematically illustrated by fibers 28-30 in FIG. 1. For a PON system, the fibers are combined external to the transceiver. The number of such connections is of course not limited to those illustrated and transceiver 10 could be coupled to a large number of separate optical networking units in a given application, and such multiple connections are implied herein.

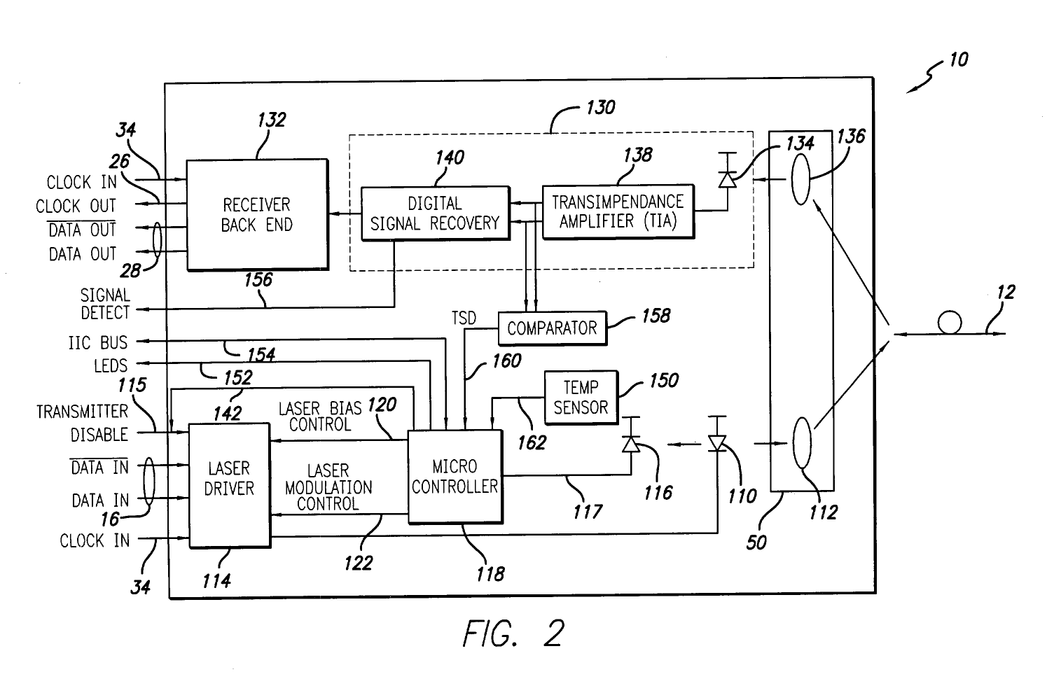

Referring to FIG. 2, a block schematic drawing of a transceiver coupled to a single optical fiber 12 in accordance with the present invention is illustrated. The transceiver illustrated in FIG. 2 may correspond to either transceiver 10 or 20 illustrated in FIG. 1 or another transceiver in the network although it is denoted by reference numeral 10 in FIG. 2 and in the following discussion for convenience of reference. The transmitter portion of transceiver 10 may operate in a continuous mode, for example, in an application where the transceiver is an OLT in a fiber optic network. Alternatively, the transmitter may operate in a burst mode, for example, if transceiver 10 is an ONU in a PON fiber optic network. Also, the transmitter may have the capability to operate in both burst and continuous modes at different times. As illustrated, the transmitter portion of transceiver 10 includes a laser diode 110 which is coupled to transmit light into optical fiber 12. Optics 50 is adapted to deliver modulated light to fiber 12 from the transmitter portion of transceiver 10 and to provide incoming modulated light from fiber 12 to the receiver portion. The optics 50 is generally illustrated schematically in FIG. 2 by first and second lenses 112, 136, however, optics 50 may include filters and beams splitters to separate the wavelengths of light corresponding to the transmit and receive directions in a wavelength division multiplexing implementation of the single fiber transceiver. (See U.S. application Ser. No. 09/836,500 filed Apr. 17, 2001 for OPTICAL NETWORKING UNIT EMPLOYING OPTIMIZED OPTICAL PACKAGING, the disclosure of which is incorporated herein by reference in its entirety). In an implementation of the single fiber transceiver employing a single wavelength of light, optics 50 may simply include the lenses, beam splitter or other optics to optically couple both the transmit laser diode and the receive photodiode to fiber 12.

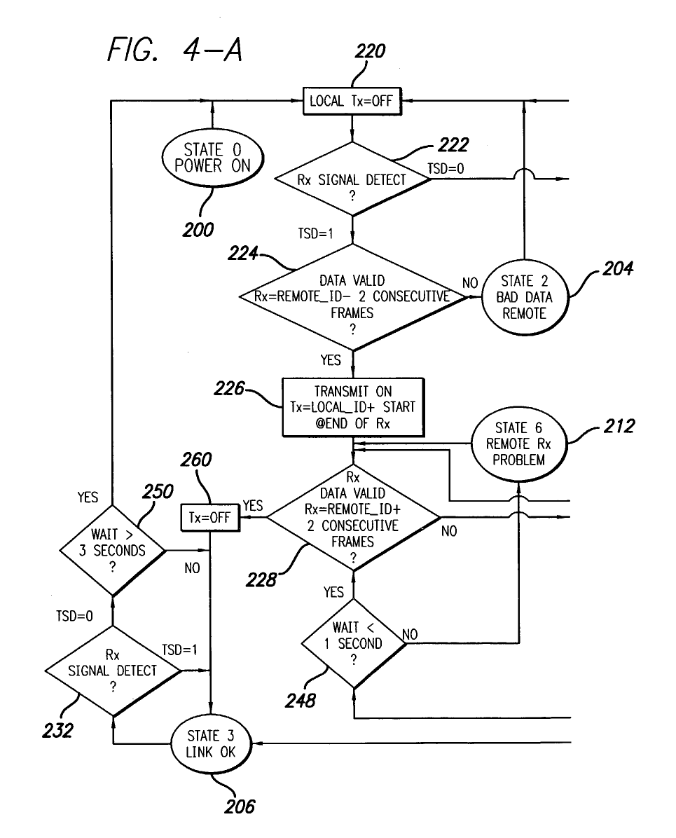

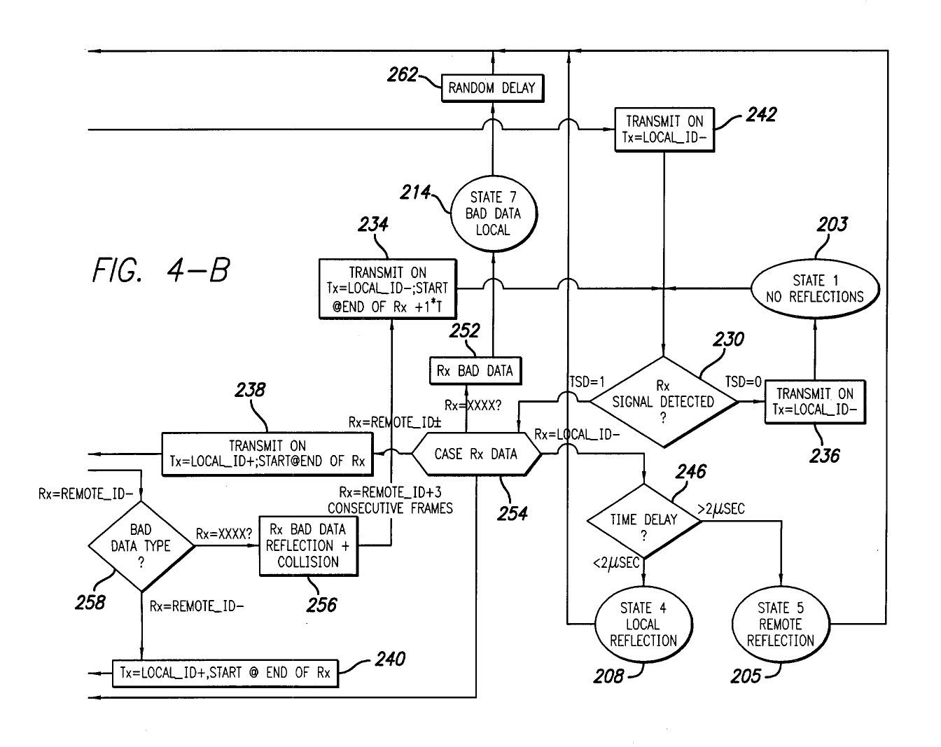

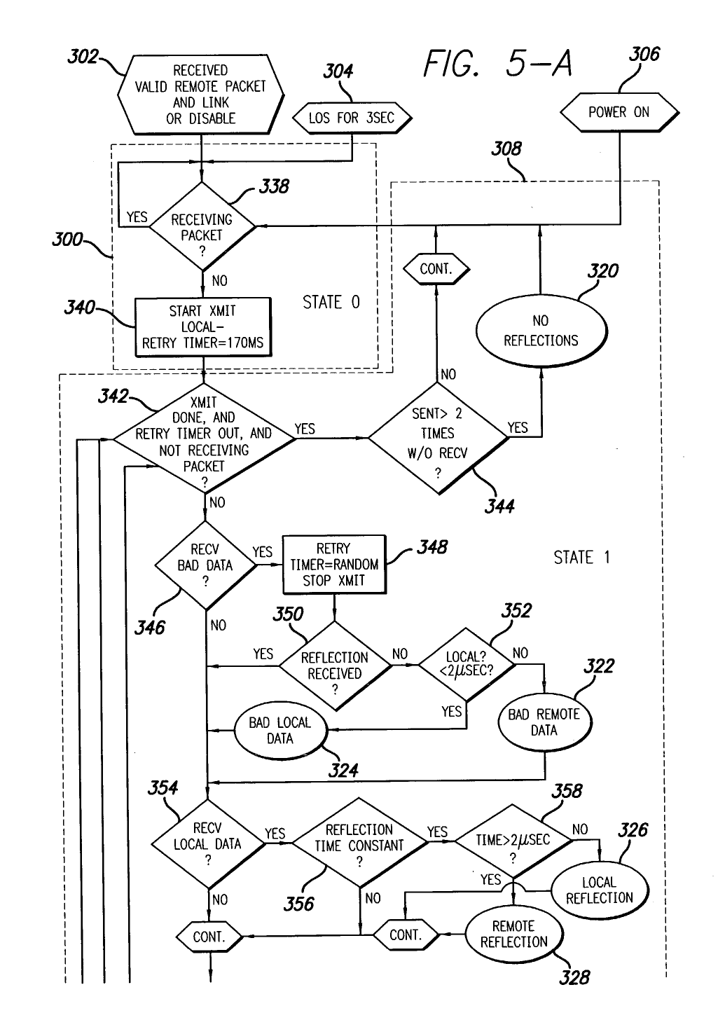

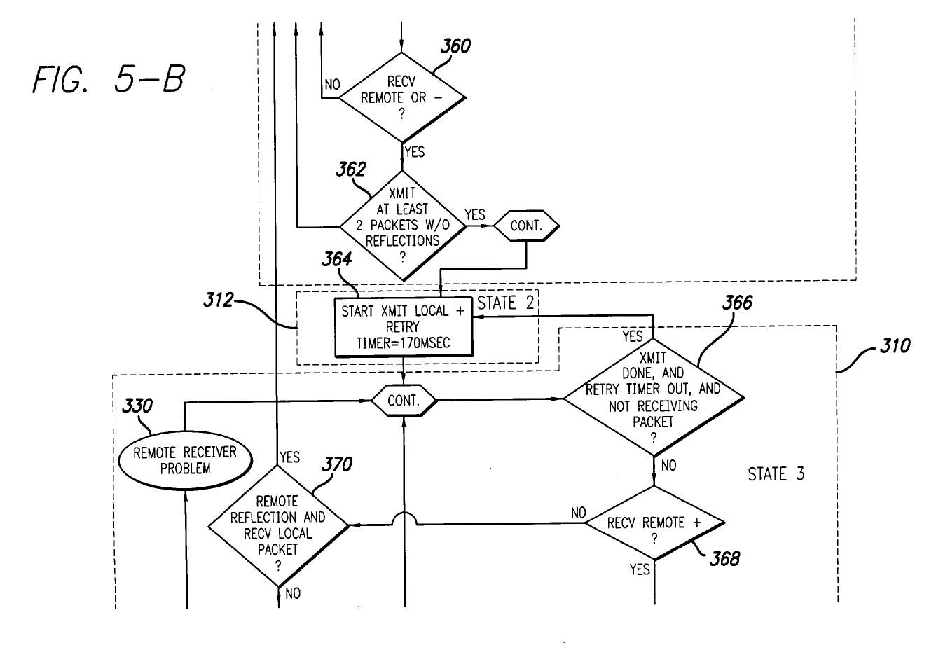

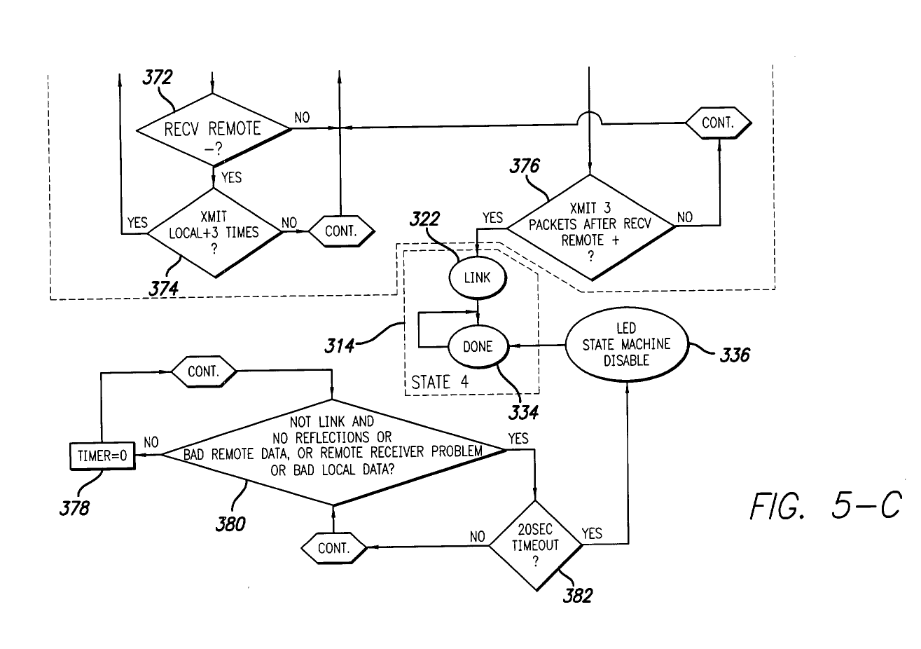

Laser diode 110 is coupled to laser driver 114 which drives the laser diode in response to the data input provided along lines 16 to provide the modulated light output from laser diode 110. In particular, the laser driver provides a modulation drive current, corresponding to high data input values (or logic 1), and a bias drive current, corresponding to low data input values (or logic 0). During normal operation the bias drive current will not correspond to zero laser output optical power. Various modulation schemes may be employed to encode the data, for example, NRZ encoding may be employed as well as other schemes well known in the art. In addition to receiving the data provided along lines 16 the laser driver 114 may receive a transmitter disable input along line 115 as illustrated in FIG. 2. This may be used to provide a windowing action to the laser driver signals provided to the laser diode to provide a burst transmission capability in a transmitter adapted for continuous mode operation to thereby provide dual mode operation. The microcontroller 118 may disable the laser driver 114 via line 142 to enable reception without potential cross talk with the transmitted signal. During the test mode the transmitter disable blocks and effect of external data 16 on the output of the laser driver 114. The laser driver 114 may also receive a clock input along line 34 which may be used to reduce jitter in some applications. As further illustrated in FIG. 2, a back facet monitor photodiode 116 is preferably provided to monitor the output power of laser diode 110. The laser output power signal from back facet monitor photodiode 116 is provided along line 117 to microcontroller 118 which adjusts a laser bias control input to the laser driver 114 and a laser modulation control input to the laser driver 114, along lines 120 and 122, respectively. Microcontroller 118 may also receive a temperature signal from temperature sensor 150 which monitors the internal temperature of the transceiver and connects to the microcontroller 118 via line 162. This temperature reading can be used to compensate the laser bias current and modulation current with changes in temperature. The modulation and bias control signals thus allow the laser driver 114 to respond to variations in laser diode output power, which power variations may be caused by temperature variations, aging of the device circuitry or other external or internal factors. This allows a minimum extinction ratio between the modulation and bias optical power levels, e.g., 10 to 1, to be maintained. To allow rapid response to the modulation and bias control signals preferably a high speed laser driver is employed. For example, a Vitesse VSC7923 laser driver or other commercially available high speed laser driver could be suitably employed for laser driver 114. Microcontroller 118 also has an interface 154 to transfer and receive test, maintenance and transceiver ID data to and from the user. Microcontroller 118 also provides visual status indications, e.g., to LEDs, along lines 152. Interface 154 may, for example, be a serial IIC interface bus. The functions of microcontroller 118 will be described in more detail below in relation to the discussion of the microcontroller block diagram of FIG. 3 and the flow diagrams of FIGS. 4 and 5.

Still referring to FIG. 2, the receiver portion of the transceiver 10 includes a front end 130 and a back end 132. Front end 130 includes a photodetector 134, which may be a photodiode, optically coupled to receive the modulated light from fiber 12. Photodiode 134 may be optically coupled to the fiber 12 via passive optics illustrated by lens 136. Passive optical components in addition to lens 136 may also be employed as will be appreciated by those skilled in the art. The front end 130 of the receiver further includes a transimpedance amplifier 138 that converts the photocurrent provided from the photodiode 136 into an electrical voltage signal. The electrical voltage signal from transimpedance amplifier 138 is provided to digital signal recovery circuit 140 which converts the electrical signals into digital signals. That is, the voltage signals input to the digital signal recovery circuit from transimpedance amplifier 138 are essentially analog signals which approximate a digital waveform but include noise and amplitude variations from a variety of causes. The digital signal recovery circuit 140 detects the digital waveform within this analog signal and outputs a well defined digital waveform. A suitable digital signal recovery circuit is disclosed in co-pending U.S. patent application entitled “Fiber Optic Transceiver Employing Front End Level Control”, to Meir Bartur and Farzad Ghadooshahy, Ser. No. 09/907,137 filed Jul. 17, 2001, the disclosure of which is incorporated herein by reference. When the digital signal recovery circuit 140 detects the digital waveform of an incoming signal an output signal detect (SD) signal is provided along line 156, which may provide a visual indication of a received signal for the user. A second signal detect (Test Signal Detect—TSD) signal which is used only internally is detected by comparator 158 which is coupled to the differential output of transimpedance amplifier 138. This signal TSD is provided to microcontroller 118 via line 160 and used in a manner described in detail below. It is also possible to connect the signal detect (SD) signal provided along line 156 to the microcontroller 118 and provide an alternative output from the microcontroller 118 that combines the information received from SD and TSD. The output TSD is valid when the light intensity is above a preset threshold and is invalid when the light intensity is below this threshold. As discussed below, this threshold may optionally be varied under the control of microcontroller 118 in which case microcontroller 118 will have a control line coupled to comparator 158. The comparator circuit may include a hysteresis circuit to limit oscillation at the transition between the valid and invalid state. This comparator circuit is used to process low frequency test data as will be discussed in more detail below.

The digital signals output from digital signal recovery circuit 140 are provided to the back end of the receiver 132 which removes signal jitter, for example using a latch and clock signal to remove timing uncertainties, and which may also derive the clock signal from the digital signal if a clock signal is desired. In the latter case the receiver back end 132 comprises a clock and data recovery circuit which generates a clock signal from the transitions in the digital signal provided from digital signal recovery circuit 140, for example, using a phase locked loop (PLL), and provides in phase clock and data signals at the output of transceiver along lines 26 and 28, respectively. An example of a commercially available clock and data recovery circuit is the AD807 CDR from Analog Devices. Also, the receiver back end 132 may decode the data from the digital high and low values if the data is encoded. For example, if the digital signal input to the clock and data recovery circuit is in NRZ format, the clock and data recovery circuit will derive both the clock and data signals from the transitions in the digital waveform. Other data encoding schemes are well known in the art will involve corresponding data and clock recovery schemes. In the case of synchronous systems, such as PON optical networks, the clock may be available locally and the back end 132 aligns the phase of the incoming signal to the local clock, such that signals arriving from different transmitters and having differing phases are all aligned to the same clock. In this case the clock signals are inputs to the receiver back end from the local clock provided along line 34. A suitable clock and data phase aligner for such a synchronous application is disclosed in co-pending U.S. patent application entitled “Fiber Optic Transceiver Employing Clock and Data Phase Aligner”, to Meir Bartur and Jim Stephenson, Ser. No. 09/907,057 filed Jul. 17, 2001, the disclosure of which is incorporated herein by reference.

Referring to FIG. 3, a block schematic drawing of the microcontroller 118 is shown. As discussed briefly above, the microcontroller sets the laser bias and modulation current, monitors the laser bias and modulation current, monitors the back facet photo diode current along line 117, power supply voltage along line 82, and communicates with the user through a IIC bus and visual status lights operated through the either the digital I/O 74 or output 152 from the DACs. These functions are performed by executing suitable program code in CPU 73. The microcontroller 118 also contains an identification stored in memory 75 that can be read by the user through the IIC interface (e.g., 128 bytes of data).

More specifically, the microcontroller 118 sets the bias current and modulation current by setting the digital values of the digital to analog converters (DACs) 76. The analog output values set the bias and modulation set point voltages for the laser driver 114. The power may be factory set or user settable through the IIC bus. The DACS may be implemented as pulse width modulators (PWM). The microcontroller will automatically adjust the bias and modulation set point voltages to adjust for variations in laser power with changes in temperature. During the manufacture of the transceiver, the transmitter is characterized by measuring the laser output power over temperature and storing this information in the microcontroller memory 75. The microcontroller uses this information to determine the set points for any particular temperature.

The microcontroller 118 monitors the back facet photo diode current, provided along line 117 via Multiplexor (MUX) 71 to CPU 73, along with the bias current and modulation current. If any of these exceed preset values, setting the bias and modulation set points to the no current condition turns off the laser current. The microcontroller indicates an error condition and is left in this condition until power is cycled to the unit or reset via other commands. The user may read and reset the error status through the IIC interface. Optionally, the microcontroller may perform an automatic recovery by re-applying the bias and modulation set point voltages and monitoring the back facet photo diode, bias current and modulation current. The transceiver would again shut down if any of these exceed preset values. The microcontroller 118 monitors the back facet photodiode current to generate an End of Life condition that can be probed through the IIC interface. At an instance when a laser power is dropping below a set value an error condition may alert the system operator for a need to replace a faulty transceiver.

When power is first applied to the transceiver, or whenever a test mode is initiated, the transceiver will perform a power up fiber test that measures the communications between the near and far transceivers and monitors reflections for a single wavelength system. This test will validate that the two transceivers are connected and can communicate correctly. This protocol can determine if fiber is open, or if the fiber contains reflections. If reflections are determined, the protocol can determine if the reflections are occurring at the near end or far end, and the approximate location of the reflections based on the delay time between the transmit and receive signals. Finally the user can interrogate the identification of the far end transceiver. A visual indication of status may also be provided, e.g., by a pattern of colored lights.

The test mode includes the transfer of data between the near and far end transceivers in a transmission mode which is different than normal user data transmission so that it is not confused with normal user data, and the Signal Detect (SD) flag output to the user on line 156 will be low throughout the test mode. Data may be transferred between the near and far end transceivers using a different frequency range, e.g., MHz or lower for test mode and GHz for normal user data transfer, a different modulation scheme, e.g., pulse width modulation may be employed for test mode and NRZ for normal data transfer, and/or a different power range may be employed for test mode. Preferably a combination of these different transmission characteristics are employed for test mode communication between near and far end (local and remote) transceivers. For example, during test mode the modulation current for the laser diode may set to 0 by setting the modulation set point voltage to the 0 current value. The microcontroller 118 then transmits pulse width modulated data by changing the bias set point between 0 power and maximum bias power by controlling the digital to analog converter. The far end receiver then receives this data where it is fed to the microcontroller through the comparator 158. The comparator output high thus represents a test signal detect (TSD) which can be modulated to transfer test data and is used only internally. For pulse width modulated test data the timer 178 within the microcontroller measures the pulse width of the TSD signal and determines if the data is a one or a zero. During normal operation the output of the comparator is always at a valid logic level as the power provided by the bias power level at the remote transmitter results in a signal that is above the set point of the comparator even for the weakest input signal.

One particular advantage of the test mode processing described herein pertains to reflection location as well as detection. As discussed above reflections are a very significant problem for single fiber single wavelength links where the transmitted wavelength and the received wavelength are traveling on the same fiber, and the receiver is sensitive to the same wavelength as the transmitter (duplex operation).

In accordance with the test mode protocol, upon detection of loop back data—the condition where the data received during link establishment is identical to the one transmitted (applicable to single fiber single wavelength links) which indicates an open fiber that provides reflections that are detected by the comparator 158—the transceiver can provide coarse measurement of the location of the open fiber. That is, once it is established through data correlation that an instance of reflection occurs, the location of the reflecting spot can be estimated. By sending a short pulse and monitoring the comparator (issuing an interrupt in the microcontroller 118) the transceiver can measure the round trip delay to the fault. For example a microcontroller 118 operating at 4 MHz clock can detect the reflection within accuracy of similar or better that 4 clock units. The propagation speed of light in the fiber is ˜200 m/μSec. A round trip delay of 1 μSec (4 clock cycles) represents a fault at 100 m from the source. As discussed below, this information can be used to identify reflections as local or remote. The timing information, translated to distance, can also be made available via the IIC interface 77 to a host or other higher layer of the system. By measuring internal delays of the components during fabrication those delays can be offset from the raw time difference for increased accuracy.

Another aspect of the test mode control using the microcontroller 118 is the ability to adjust power to the laser driver in response to the detection of reflections in the network. Optical networks sometimes suffer from imperfect connections that are characterized by increased loss in the connection and reflecting some portion of the light back to the transmitter. An open connector (glass to air interface) results in ˜14.5 dB ORL (Optical Return Loss—the measure of the amount of power reflected back in dB). Operating a single fiber single wavelength link may have instances during testing or installation when the link is open—resulting in an open connector. The threshold level of the comparator 158 can be adjusted during manufacturing such that a 14 dB ORL reflection will be below such threshold (called Test Signal Detect threshold) and reflections from an open connector will not be identified. In order to enable fault location estimation as described above, and still provide link indication properly during operation (the above method can not distinguish a link opened during operation, hence the signal level of the comparator threshold must be set quite high), the comparator 158 threshold level must be adjustable. For example, the comparator 158 may be designed so that the level of threshold is controlled by a resistor, (for example post amplifiers are commercially available from Maxim with built in signal detect that is adjustable via changing of a resistor value) and using a variable resistor whose value the microcontroller can adjust (e.g. Maxim MAX5160), both tasks can be achieved. During the operation of the test mode state flow (as described below) a low value threshold is established and reflection can be found and localized. Afterwards for continuous link operation a higher threshold will be used to avoid open connector reflections.

Another approach to enable fault isolation, utilizing the features of open loop microcontroller 118, is to control the laser power to maximum for the pulse used to measure reflections. Since the microcontroller 118 controls laser bias and modulation, large power pulses for measurement purpose can be sent. The reflected signal will be higher and can be detected while the threshold level of the comparator is fixed.

A specific detailed embodiment of a test mode protocol, and associated method of operation of the transceiver, is described in the state flow diagram of FIG. 4 and the below Table 1. The following definitions are employed in FIG. 4 and the Table.

### DEFINITIONS

ID—bit word e.g. 128 bits that is unique to the specific transceiver (each is different). It Includes a representation of link status (e.g. last bit 0—not linked, 1—linked)

Local_ID−—the ID of the local Transceiver while NOT linked

Local_ID+—the ID of the local Transceiver while linked

Remote_ID−—the ID of the remotely linked Transceiver while NOT linked

Remote_ID+—the ID of the remotely linked Transceiver while linked

Tbit—the time period for single bit transmission during test mode

Tid—Tbit*(bit length of ID)

Tframe—m* Tid, 1<m<10. (For example m=3)

Frame—a transmit sequence that starts with ID followed by no transmission for a period of (m−1)*Tid

SD—signal detect. Based on receiving a signal at the receiver the SD flag is set instantly (typically faster than Tbit) and stays 1 for a period greater than 1*Tframe and smaller than 5*Tframe.

End of Rx—consecutive 0's that exceed the total amount of consecutive 0's allowed in the ID.

TABLE 1

| STATE | Condition | Description | Light |
|---|---|---|---|
| 0 | No Power | Includes also initial state | None |
| | | search after turn-on | |
| 1 | Tx on, NO local | Other side is not connected, or | Flash |
| | Reflections | not powered | grn/dark |
| 2 | Rx error, Tx off | Input Signal undetermined | Flash |
| | | | grn/grn/red |
| 3 | Link | Confirmed link no reflections | grn |
| 4 | Local | Reflection delay < 2 uSec | red |
| | Reflections | | |
| 5 | Remote | Reflection delay > 2 uSec | Flash |
| | Reflections | | grn/red/grn |
| 6 | Remote Rx OR | Receive valid data, no | Flash |
| | Local Tx | reflections, no confirmation | red/dark |
| | problem | | |
| 7 | Rx error, Tx | Input Signal undetermined | Flash |
| | ON | | red/grn/red |

Referring now to FIG. 4, a state flow diagram showing the operation of the test mode implemented by the microcontroller in accordance with a first embodiment of the present invention is illustrated.

At initial state 200, which may be considered state 0 in the flow diagram, the transceiver is powered on initiating the test mode state flow processing. The power on state 200 may occur during initial installation of the transceiver into the fiber optic network or power off/on or may be initiated in response to a fault situation occurring during operation of the transceiver in the network. After the test mode is initiated at state 0 by power on of the transceiver microcontroller 118 proceeds to implement the state flow processing to determine which of the operating states the transceiver connection is applicable. More specifically, the microcontroller 118 implements the processing to determine an operating state of the transceiver connection to the network as either state 1, indicated at 203 in the state flow diagram and corresponding to the far end transceiver either not connected or not powered up, state 2, indicated at 204 in the state flow diagram and corresponding to an undetermined input signal, state 3, indicated at 206 in the state flow diagram corresponding to a confirmed link with the far end transceiver with no reflections, state 4, indicated at 208 in the state flow diagram, corresponding to detected reflections corresponding to a local problem in the fiber connection, state 5, indicated at 205 in the state flow diagram and corresponding to detected reflections indicating a problem in the far end (remote) fiber connection, state 6, indicated at 212 in the state flow diagram and corresponding to a remote receiver problem or a local transmitter problem corresponding to received data from the far end transceiver but no confirmation of the link from the far end transceiver, or state 7, indicated at 214 in the state flow diagram corresponding to an undetermined input signal and a local receiver error.

In processing the test mode state flow to determine the state of the link as illustrated in FIG. 4, the microcontroller 118 initiates a sequence of actions comprising transmission of test data from the local transceiver and detection of test data, i.e. signal TSD, either from the far end transceiver with the appropriate modulation for a confirmation of the remote transceiver or test data corresponding to the local transceiver ID indicating a reflection.

More specifically, referring to FIG. 4, the transceiver actions in the flow between the different state determinations may comprise the following: at 220 the local transceiver transmitter is off and the test mode is initiated; at 222, 230 and 232 the local transceiver examines the output of the comparator to see if the signal TSD is high or low; at 224, 228 and 254 the local transceiver examines the data modulated on the TSD signal for a valid confirmation from the remote transceiver, e.g. the transmission of the remote transceiver ID followed by a confirmation of the ID in a consecutive frame; at 226, 234, 236, 238, 240 and 242 the local transceiver transmitter is on transmitting test data in the form of the local transceiver ID; at 246 the time difference between transmission and receiving the reflection (e.g. 2 μsec) is instituted to determine if a reflection is local or remote; at 236, 248 and 250 time delays are initiated before continuing further processing in the state flow; at 252, 254, 256, and 258 received data is identified as bad either due to a reflection or error in the local transceiver or far transceiver; at 262 a random delay is initiated before resuming initial test mode processing; and at 260 the local transmitter is turned off.

Accordingly, it will be appreciated that the microcontroller initiates the test mode state flow between the various indicated states and provides an appropriate indication to the user, e.g. via the use of flashing sequences of colored LEDs. Furthermore, this test mode processing is provided using a minimum of different local transceiver initiated actions and minimal additional hardware.

Referring to FIG. 5, an alternative implementation of the test mode processing flow is illustrated. In the state flow diagram of FIG. 5, the separate states 0, 1, 2, 3, and 4 are more generally indicated than in the previous embodiment and are not in direct corrspondance. More specifically, state 0, indicated at 300 in the state flow diagram corresponds to transmission of the local− packet as in the previous embodiment and may be initiated from receipt of a test mode data packet from a far end transceiver at 302, a loss of signal (LOS) for a predetermined period time indicated at 304, or an initial power on of the transceiver at 306. State 1 and state 3 in turn, indicated at 308 and 310, respectively, correspond to a series of bad connection determinations either due to bad local data, bad remote data, local reflections, or remote reflections. . State 1 is exited when a valid remote+ or remote− data packet is received. State 3 is exited when a valid remote+ packet has been received and the local+ packet has been transmitted at least 3 times. State 2 in turn corresponds corresponds to the transmission of the local+ packet and is indicated at 312 in the state flow diagram. Finally, state 4, indicated at 314 in the state flow diagram corresponds to a confirmed link with the far end transceiver. A variety of different status lights may be provided as in the previous embodiment and the various status indications are illustrated in the state flow diagram at 320 no reflections, 322 bad remote data, 324 bad local data, 326 local reflections, 328 remote reflections, 330 remote receiver problem, 332 confirmed link established, 334 test mode completed, and 336 test mode disabled.

Additional stages in the state flow processing correspond to the local transceiver actions initiating the processing flow between the indicated states as follows: receiving test data determination at 338; transmit test data (local ID) from local transceiver at 340; determination of test data transmission complete, retry timer timed out and no valid test data at 342; determination of transmitter data sent more than two times without received data at 344; determination of received data bad or good at 346; retry timer initiation to a random delay at 348; testing if reflection has been seen at 350; determination if reflected data is local or not at 352; determination of received local data at 354; determination of reflection time constant at 356; determination of reflection time delay at 358; determination of receiving remote data at 360; transmission of at least two packets of data without reflections determination at 362; start transmission of test data from local transceiver at 364; determination of transmission completed, retry timer timed out and not receiving test data at 366; determination if received data is remote+ test data packet at 368; determination of remote reflections and received local test data packet at 370; determination if received remote data is remote− test data at 372; determination of transmitting local± test data at least three times at 374; determination of transmitting at least three packets of local+ test data after receiving remote test data at 376; test mode timer initiation at 378; determination of state machine activity at 380; and determination of test mode timeout at 382.

As in the case of the previously described embodiment, it will be appreciated that the state flow diagram of FIG. 5 implements an effective test mode processing utilizing relatively few local transceiver initiated actions and with relatively straightforward test data modulation and detection at the local transceiver level.

Therefore, it will be appreciated that the present invention provides an optical transceiver adapted for use in an optical fiber data transmission system which is capable of detecting fiber connection problems and providing visual or other indications of a problem and/or reconfiguring the connection automatically, in response to a connection problem. The present invention further provides an optical transceiver, which can provide such capability without significant added cost or complexity.

Although the present invention has been described in relation to specific embodiments it should be appreciated that the present invention is not limited to these specific embodiments as a number of variations are possible while remaining within the scope of the present invention. In particular, the specific circuit and state flow implementations illustrated are purely exemplary and may be varied in ways too numerous to enumerate in detail. Accordingly they should not be viewed as limiting in nature.

What is claimed is:

1. An optical transceiver, comprising:
a transmitter comprising a laser diode and a laser driver providing a drive signal to the laser diode;
a receiver comprising a photodiode and signal recovery circuitry; and
a microcontroller coupled to the transmitter and receiver and providing a modulated power control signal to the laser driver during a test mode to transmit test data and monitoring received signals to detect connection problems.

2. An optical transceiver as set out in claim 1, wherein said laser driver has modulation and bias power control inputs and wherein said microcontroller modulates said bias control input during said test mode.

3. An optical transceiver as set out in claim 1, wherein said microcontroller modulates said power control signal employing pulse width modulation.

4. An optical transceiver as set out in claim 1, wherein said receiver further comprises a transimpedance amplifier coupled to the photodiode and wherein said microcontroller monitors the output of said transimpedance amplifier during said test mode.

5. An optical transceiver as set out in claim 4, further comprising a comparator coupled between the output of said transimpedance amplifier and said microcontroller, for detecting test signals at the output of the transimpedance amplifier.

6. An optical transceiver as set out in claim 5, wherein said comparator provides a first output when the transimpedance amplifier output is above a threshold value and a second output when it is below said threshold value.

7. An optical transceiver as set out in claim 6, wherein the test signals comprise low frequency signals.

8. An optical transceiver as set out in claim 1, wherein said test mode is initiated during initial power up of the transceiver.

9. An optical transceiver as set out in claim 1, wherein said transceiver comprises a visual indicator which is activated to identify a fiber connection state detected during said test mode.

10. A fiber optic communication network, comprising:
an optical fiber;
a first transceiver coupled to the optical fiber and comprising a transmitter including a laser diode and a laser driver providing a drive signal to the laser diode, a receiver including a photodiode and signal recovery circuitry, and a microcontroller coupled to the transmitter and receiver and providing a modulated power control signal to the laser driver during a test mode to transmit test data and monitoring received signals to detect connection problems; and
a second transceiver coupled to the optical fiber and comprising a transmitter including a laser diode and a laser driver providing a drive signal to the laser diode, a receiver including a photodiode and signal recovery circuitry, and a microcontroller coupled to the transmitter and receiver and providing a modulated power control signal to the laser driver to provide test data in response to received test data from said first transceiver.

11. An optical transmitter as set out in claim 10, wherein said test data comprises data identifying the transceiver.

12. An optical transmitter as set out in claim 10, wherein the first transceiver monitors received signals for reflected test data identifying the first transceiver and wherein the reflected test data indicates fiber connection problems.

13. An optical transmitter as set out in claim 12, wherein the first transceiver transmits a short duration test signal when reflected test data is detected and said first transceiver includes a timer for detecting the time delay of the reflected test signals and the microcontroller determines the location of the reflection.

14. An optical transmitter as set out in claim 13, wherein the microcontroller increases the power to the laser driver for the short duration reflection test signal.

15. An optical transmitter as set out in claim 12, wherein the microcontroller adjusts the test signal detection threshold based on the detected reflection to enable normal data transmission despite the reflection.

16. A method for fault detection in a fiber optic network, comprising:
transmitting a test signal by modulating a laser transmitter using a test transmission mode which is different than a data transmission mode during normal operating conditions; and
detecting any received signals modulated using said test transmission mode within a predetermined time period after said transmitting.

17. A method for fault detection in a fiber optic network as set out in claim 16, wherein said test transmission mode comprises modulating the laser at a power level below the minimum threshold for normal data transmission.

18. A method for fault detection in a fiber optic network as set out in claim 16, wherein said test transmission mode comprises modulating the laser at a frequency substantially lower than during normal data transmission.

19. A method for fault detection in a fiber optic network as set out in claim 16, wherein said test transmission mode comprises modulating the laser using a different modulation scheme than normal data transmission.

20. A method for fault detection in a fiber optic network as set out in claim 19, wherein said test transmission mode comprises modulating the laser using pulse width modulation.

21. A method for fault detection in a fiber optic network as set out in claim 17, wherein said test transmission mode comprises modulating the laser bias control setting.

22. A method for fault detection in a fiber optic network as set out in claim 16, wherein said test signal comprises an ID characterizing the local transmitter.

23. A method for fault detection in a fiber optic network as set out in claim 22, further comprising determining whether a received test signal comprises the ID for the local transmitter.

24. A method for fault detection in a fiber optic network as set out in claim 23, further comprising initiating a short duration test pulse if the received test signals comprise the ID for the local transmitter.

25. A method for fault detection in a fiber optic network as set out in claim 24, further comprising detecting the time delay for receiving the reflected test pulse and determining the location of the reflection.

26. A method for fault detection in a fiber optic network as set out in claim 24, further comprising increasing the laser transmitter power during transmission of said short duration test pulse.

27. A method for determining a connection state of a fiber optic network, comprising:
connecting a local fiber optic transceiver to a fiber optic network comprising at least one optical fiber and at least one remote transceiver;
initiating a test mode wherein the local fiber optic transceiver transmits optical test signals employing a transmission mode which is different than for transmission of user data during normal operation;
detecting any received signals modulated using said test transmission mode;
identifying at least one connection state of the local fiber optic transceiver in the network based on said transmitting of test signals and said detecting of received signals; and
providing an indication of the connection state to a user.

28. A method for fault detection in a fiber optic network as set out in claim 27, wherein said indication comprises a visual indication.

29. A method for fault detection in a fiber optic network as set out in claim 27, wherein said at least one connection state includes a connection state indicating a reflection.

30. A method for fault detection in a fiber optic network as set out in claim 29, wherein in said connection state the reflection is identified as local or remote.
